(19) United States
(12) Patent Application Publication
(10) Pub. No.: US 2003/0184847 A1
(43) Pub. Date: Oct. 2, 2003

(54) Optical multiplexers and demultiplexers

(76) Inventor: Ralf-Dieter Pechstedt, Oxfordshire (GB)

Correspondence Address: Mark D. Saralino, Esq., Renner, Otto, Boisselle & Sklar, LLP, 19th Floor, 1621 Euclid Ave., Cleveland, OH, 44115, US

(21) Appl. No.: 10/390,382

(22) Filed: Mar. 17, 2003

(30) Foreign Application Priority Data
Mar. 19, 2002 (GB) 0206473.1

(51) Int. Cl. H01S 3/00

(52) U.S. Cl. 359/333

(57) ABSTRACT

An A-VMUX comprises a AWG having N channel waveguides incorporating VOAs and receiving channel signals by way of a AR coating, and an output waveguide. An ordinary SOA is provided in the output waveguide for amplifying the multichannel output signal supplied to the optical fibre, and an auxiliary waveguide is provided for supplying a lasing signal to the AWG having a wavelength outside the main signal wavelength band in order to provide gain-clamping of the SOA. The auxiliary waveguide is provided with a highly reflective (HR) coating at the edge of the chip that forms a lasing cavity with the Bragg grating provided in the optical fibre. Furthermore an intra-cavity VOA is provided for attenuating the lasing signal. Such an arrangement uses the wavelength selecting function of the AWG to provide the required gain-clamping of the SOA with the Bragg grating being selected to match the wavelength of the auxiliary channel provided by the auxiliary waveguide. The level at which the gain clamps, and accordingly the value of the amplifier gain, is easily adjusted by adjusting the VOA to vary the intra-cavity losses within the cavity. Thus a linear amplifier with variable gain is realised which can be integrated on a silicon chip by SOI fabrication.

The present invention relates to optical multiplexers and demultiplexers.

### BACKGROUND OF THE INVENTION

It is well known to incorporate a semiconductor optical amplifiers (SOAs) within an optical device having a waveguide structure in order to amplify an optical signal. SOAs are also known which are gain-clamped so as to have a substantially linear gain response over a range of optical signal wavelengths. Such SOAs are known as linear optical amplifiers (LOAs). “Polarisation-Insensitive Clamped-Gain SOA with Integrated Spot-Size Convertor and DBR Gratings for WDM Applications at 1.55 μm Wavelength”, M. Bachmann et al., Electronics Letters, Vol. 32, No. 22, p. 2076 (1996) discloses such a gain-clamped SOA incorporating input and output DBR gratings for wavelength selective feedback. However such devices are more complicated than ordinary SOAs and require additional processing steps for their fabrication, which causes them to be expensive.

It is also known to gain-clamp an ordinary SOA to ensure substantially constant gain over a range of wavelengths. This requires additional wavelength selective elements to provide a lasing cavity, and such elements may be gratings, thin-film filters, Mach-Zehnder interferometers and the like deployed externally of the SOA, typically on both sides of the SOA.

It is an object of the invention to provide an optical multiplexer/demultiplexer, for example an A-VMUX, which can be fabricated in a straightforward manner, for example by employing an ordinary SOA, without the need for additional processing steps as are required when LOAs are used.

### SUMMARY OF THE INVENTION

According to the present invention there is provided an optical multiplexer/demultiplexer comprising channel waveguide means for a plurality of optical channel signals of different wavelengths, input/output waveguide means for a multichannel optical signal incorporating the different channel signals, multiplexing/demultiplexing means for multiplexing or demultiplexing the optical channel signals, amplifying means for amplifying the multichannel optical signal within the input/output waveguide means, and gain clamping means for clamping the gain of the amplifying means within a required wavelength range, the gain clamping means comprising an auxiliary waveguide for conducting a lasing signal of a different wavelength to the optical channel signals within a cavity defined between a reflecting part of the auxiliary waveguide and a further reflecting part arranged so that the lasing signal passes through the multiplexing/demultiplexing means and the amplifying means within the input/output waveguide means.

Such an optical multiplexer/demultiplexer is advantageous since it is easily fabricated using known fabrication techniques, for example on a planar lightwave circuit on a SOI platform, and without having to use special processing steps for the amplifying means which is typically a SOA.

Preferably the gain clamping means incorporates optical attenuating means, such as a variable optical attenuator (VOA), for attenuating the lasing signal within the auxiliary waveguide. This enables the level at which the gain clamps to be adjusted, and thus provides a linear amplifier with variable gain.

Furthermore the channel waveguide means preferably incorporates optical attenuating means, such as a variable optical attenuator (VOA) for each channel, for attenuating the optical channel signals of different wavelengths, in order to enable adjustment of the effective gain for each signal path.

The multiplexing/demultiplexing means typically comprises an arrayed waveguide (AWR).

Furthermore the reflecting part of the auxiliary waveguide may comprise a highly reflective (HR) coating provided at a chip edge, a waveguide mirror or a reflective semiconductor optical amplifier (RSOA), and the channel waveguide means may incorporate antireflective (AR) coatings. The further reflecting part may comprise an optical fibre grating coupled to the input/output waveguide means or a waveguide grating (WG) within the input/output waveguide means (which may be incorporated within the amplifying means.

The waveguide means and the multiplexing/demultiplexing means are preferably integrally formed on a planar lightwave circuit which may be a SOI (silicon-on-insulator) planar lightwave circuit.

### BRIEF DESCRIPTION OF THE DRAWINGS

For a better understanding of the present invention and to show how the same may be carried into effect, reference will now be made, by way of example, to the accompanying drawings in which:

FIG. 1 is a schematic diagram of a known A-VMUX (arrayed variable multiplexer); and

FIGS. 2 to 7 are schematic diagrams of various embodiments of A-VMUX in accordance with the invention.

### DETAILED DESCRIPTION OF THE DRAWINGS

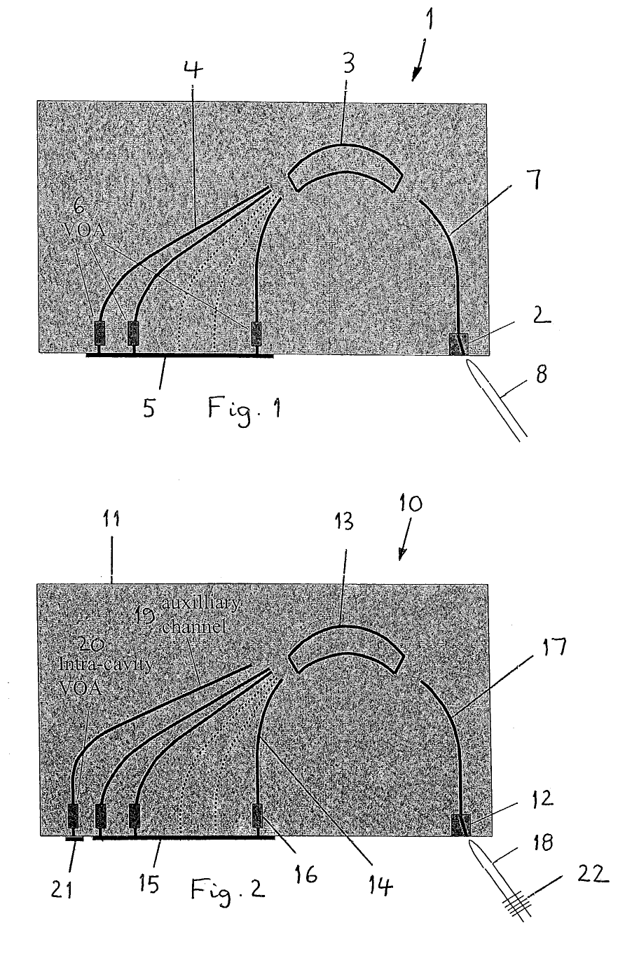

FIG. 1 shows a known A-VMUX 1 having N signal channels and employing a LOA 2 for amplifying the multichannel output signal. The A-VMUX 1 comprises a AWG 3 having N channel waveguides 4 for receiving optical channel signals applied by way of an anti-reflective (AR) coating 5 and incorporating respective VOAs 6, and an output waveguide 7 for supplying the multichannel output signal to an optical fibre 8. However the provision of the LOA 2 requires additional processing steps during fabrication and renders the device costly to produce.

FIG. 2 shows an embodiment of A-VMUX 10 in accordance with the invention integrated on a silicon chip 11 by SOI fabrication. The A-VMUX 10 comprises a AWG 13 having N channel waveguides 14 incorporating VOAs 16 and receiving channel signals by way of a AR coating 15, and an output waveguide 17. However, in this case, an ordinary SOA 12 is provided in the output waveguide 17 for amplifying the multichannel output signal supplied to the optical fibre 18, and an auxiliary waveguide 19 is provided for supplying a lasing signal to the AWG 13 having a wavelength outside the main signal wavelength band (incorporating the channel signals of different wavelengths supplied to the channel waveguides 14) in order to provide gain-clamping of the SOA 12. The auxiliary waveguide 19 is provided with a highly reflective (HR) coating 21 at the edge of the chip which forms a lasing cavity with the Bragg grating 22 provided in the optical fibre 18. Furthermore an intra-cavity VOA 20 is provided for attenuating the lasing signal which is conducted within the auxiliary waveguide 19, the AWR 13, the output waveguide 17 and the SOA 12.

Such an arrangement uses the wavelength selecting function of the AWG 13 to provide the required gain-clamping of the SOA 12 with the Bragg grating 22 being selected to match the wavelength of the auxiliary channel provided by the auxiliary waveguide 19. The level at which the gain clamps, and accordingly the value of the amplifier gain, is easily adjusted by adjusting the VOA 21 to vary the intra-cavity losses within the cavity. Thus a linear amplifier with variable gain is realised. In addition the effective gain of each channel signal path can be adjusted by the corresponding VOA 16. This additional degree of freedom provides certain advantages with respect to minimising the noise figure of the device.

Although the lasing signal is designed to have a wavelength outside the signal wavelength band to be amplified, it is desirable to minimise any amount of lasing light within the physical signal path. Where such an arrangement is used as a demultiplexer (by reversing the inputs and outputs so that a multichannel optical signal supplied to the input is demultiplexed to provide N channel signals) the residual lasing light in the signal path is mainly determined by the AWG crosstalk. As the crosstalk between adjacent channels is typically higher than the crosstalk between non-adjacent channels, it is preferred that the auxiliary channel is designed in such a manner that it is separated by at least one channel from the edge of the signal band. Where the device is used as a multiplexer, the amount of residual lasing light in the signal path is mainly determined by the reflectivity of the fibre Bragg grating, with maximum reflectivity resulting in minimum residual light.

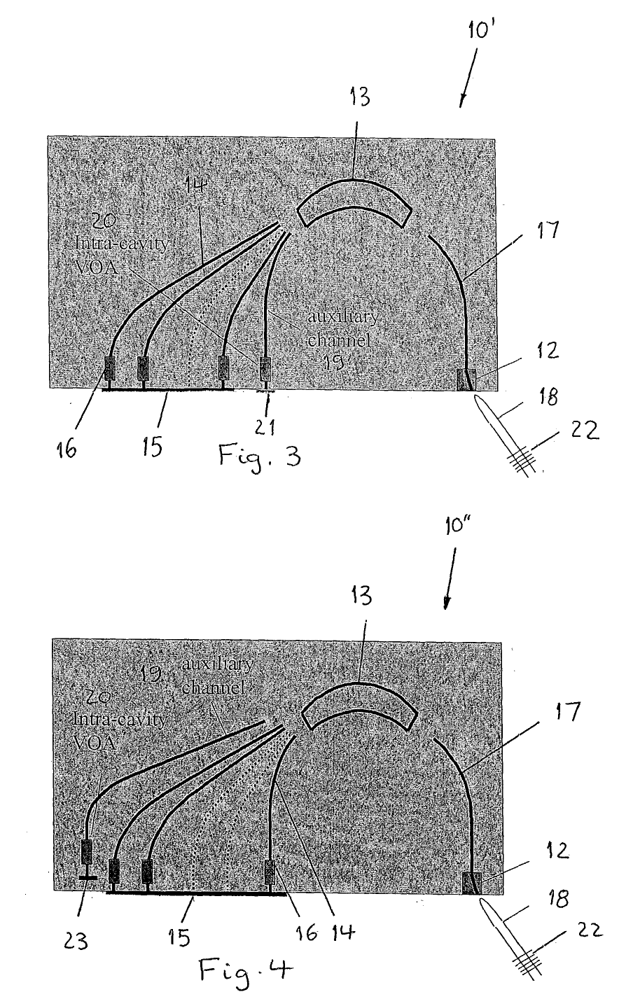

FIG. 3 shows a modification 10′ of such an arrangement in which like parts are denoted by the same reference numerals as in FIG. 2, but in which an auxiliary waveguide 19′ is provided on the opposite side of the channel waveguides 14 to that shown in the arrangement of FIG. 2. This enables the edge of the signal band at which lasing occurs to be changed.

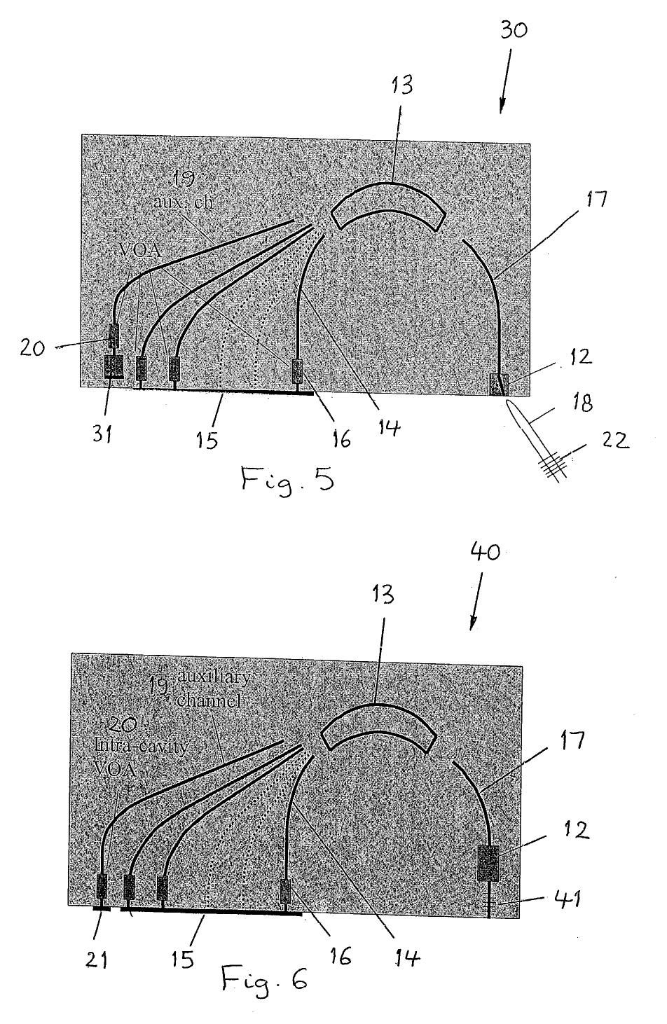

FIG. 4 shows a further modification 10″ of the arrangement of FIG. 2 in which the same reference numerals are again used to denote similar parts. In this modification the auxiliary waveguide is terminated by a waveguide mirror 23, as described in Patent Application No. [Would you please provide a publication number for this reference, if possible] The provision of such a waveguide mirror 23, in place of the HR coating 21 at the chip edge can be advantageous from the point of view of manufacturability.

FIG. 5 shows a further modification 30 of the embodiment of FIG. 2 in which the same reference numerals are used to denote similar parts. In this case the WG mirror 23 of the FIG. 4 embodiment is replaced by a reflective semiconductor optical amplifier (RSOA) 31 providing additional gain within the lasing cavity. The drive current of the RSOA 31 may be varied to change the intra-cavity losses and thus provides additional means for changing the signal gain other than varying of the attenuation applied by the VOA 20. In some circumstances this VOA can be dispensed with.

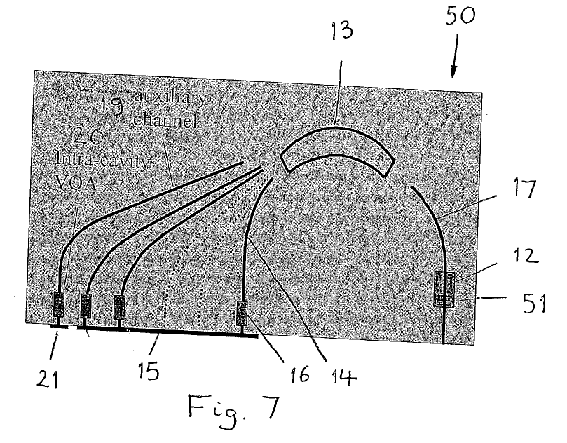

FIG. 6 shows a further modification 40 of the arrangement of FIG. 2 in which the same reference numerals are used to denote the similar parts. In this case the fibre Bragg grating is replaced by a waveguide grating 41 positioned within the output waveguide 17 in-line with the SOA 12.

In a variation 50 of such an arrangement shown in FIG. 7 a grating 51 is incorporated within the SOA 12 itself, for example as provided in a DFB or DBR laser structure.

In all of the above described embodiments use of an auxiliary AWG channel (in addition to the signal channels) serves to create a laser cavity enabling gain-clamping providing linear amplification over a required signal band, and to separate the resulting lasing light from the signal band to be amplified. This enables use of an easily fabricated SOA with one channel of the AWG providing automatic wavelength selectivity on one side of the SOA. The VOA and/or the RSOA provide variable gain-clamping level, that is variable signal gain.

Various further modifications of the embodiments described above can be contemplated within the scope of the invention, and in particular various combinations of the features described in these arrangements may be advantageous. Furthermore it will be appreciated that it may be advantageous in some circumstances to provide more than one auxiliary channel. Although the embodiments described above are multiplexers, it will be appreciated that demultiplexers provided with similar features are also within the scope of the invention.

1. An optical multiplexer/demultiplexer comprising channel waveguide means for a plurality of optical channel signals of different wavelengths, input/output waveguide means for a multichannel optical signal incorporating the different channel signals, multiplexing/demultiplexing means for multiplexing or demultiplexing the optical channel signals, amplifying means for amplifying the multichannel optical signal within the input/output waveguide means, and gain clamping means for clamping the gain of the amplifying means within a required wavelength range, the gain clamping means comprising an auxiliary waveguide for conducting a lasing signal of a different wavelength to the optical channel signals within a cavity defined between a reflecting part of the auxiliary waveguide and a further reflecting part arranged so that the lasing signal passes through the multiplexing/demultiplexing means and the amplifying means within the input/output waveguide means.

2. An optical multiplexer/demultiplexer according to claim 1, wherein the gain clamping means incorporates optical attenuating means for attenuating the lasing signal within the auxiliary waveguide.

3. An optical multiplexer/demultiplexer according to claim 2, wherein the optical attenuating means for attenuating the lasing signal is a variable optical attenuator (VOA).

4. An optical multiplexer/demultiplexer according to claim 1, wherein the channel waveguide means incorporates optical attenuating means for attenuating the optical channel signals of different wavelengths.

5. An optical multiplexer/demultiplexer according to claim 4, wherein the optical attenuating means for attenuating the optical channel signals comprises a respective variable optical attenuator (VOA) for each channel.

6. An optical multiplexer/demultiplexer according to claim 1, wherein the amplifying means comprises a semiconductor optical amplifier (SOA).

7. An optical multiplexer/demultiplexer according to claim 1, wherein the multiplexing/demultiplexing means comprises an arrayed waveguide (AWR).

8. An optical multiplexer/demultiplexer according to claim 1, wherein the reflecting part of the auxiliary waveguide comprises a highly reflective (HR) coating provided at a chip edge.

9. An optical multiplexer/demultiplexer according to claim 1, wherein the reflecting part of the auxiliary waveguide comprises a waveguide mirror.

10. An optical multiplexer/demultiplexer according to claim 1, wherein the reflecting part of the auxiliary waveguide comprises a reflective semiconductor optical amplifier (RSOA).

11. An optical multiplexer/demultiplexer according to claim 1, wherein the channel waveguide means incorporates antireflective (AR) coatings.

12. An optical multiplexer/demultiplexer according to claim 1, wherein the further reflecting part comprises an optical fibre grating coupled to the input/output waveguide means.

13. An optical multiplexer/demultiplexer according to claim 1, wherein the further reflecting part comprises a waveguide grating (WG) within the input/output waveguide means.

14. An optical multiplexer/demultiplexer according to claim 13, wherein the waveguide grating (WG) is incorporating within the amplifying means.

15. An optical multiplexer/demultiplexer according to claim 1, wherein the waveguide means and the multiplexing/demultiplexing means are integrally formed on a planar lightwave circuit.

16. An optical multiplexer/demultiplexer according to claim 15, wherein the planar lightwave circuit is a SOI (silicon-on-insulator) planar lightwave circuit.
